(19) United States
(12) Patent Application Publication
(10) Pub. No.: US 2017/0306094 A1
(43) Pub. Date: Oct. 26, 2017

(54) POLYIMIDE COPOLYMER AND MOLDED ARTICLE USING SAME

(71) Applicant: SOMAR CORPORATION, Chuo-ku, Tokyo (JP)

(72) Inventor: Nao WATANABE, Chuo-ku, Tokyo (JP)

(73) Assignee: SOMAR CORPORATION, Chuo-ku, Tokyo (JP)

(21) Appl. No.: 15/515,805

(22) PCT Filed: Sep. 29, 2015
(86) PCT No.: PCT/JP2015/077476

§ 371 Date: Mar. 30, 2017

(30) Foreign Application Priority Data
Sep. 30, 2014 (JP) 2014-201052

(51) Int. Cl. C08G 73/10; C09D 179/08

(52) U.S. Cl. CPC C08G 73/1042; C09D 179/08; C08G 73/10; C08G 73/1007

(57) ABSTRACT

An object of the present invention is to provide a polyimide copolymer excelling in solder heat resistance and an adhesive property, and a molded article thereof. A polyimide copolymer is obtained by copolymerizing: (A) an acid dianhydride ingredient; (B) a diamine and/or diisocyanate ingredient represented by the following general formulas (1) to (3):

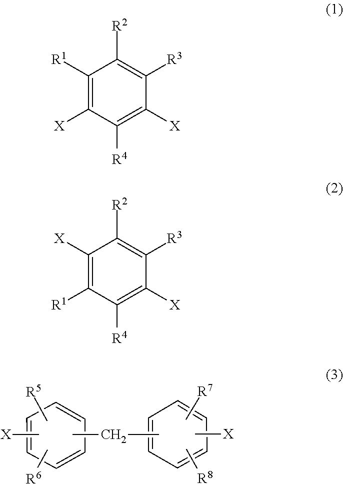

where in the formulas, X is an amino group or an isocyanate group, each of R¹ to R⁸ is independently a hydrogen atom, an alkyl group having a carbon number of 1 to 4, an alkenyl group having a carbon number of 2 to 4 or an alkoxy group having a carbon number of 1 to 4, at least one of R¹ to R⁴ is not a hydrogen atom, and at least one of R⁵ to R⁸ is not a hydrogen atom; and (C) a diamine and/or diisocyanate ingredient having at least one kind selected from an ether group and a carboxyl group.

### TECHNICAL FIELD

The present invention relates to a polyimide copolymer and a molded article using the same, and specifically to a polyimide copolymer excelling in solder heat resistance and an adhesive property to a metal foil or various kinds of films, and a molded article using the same.

### BACKGROUND ART

In recent years, highly functional information terminals requiring portability such as a smart phone and a tablet PC have become popular. In these information electronic devices, there is the need for high functionality and compactization. Highly integrated thinner electric devices are required to be mounted on electronic circuit substrates to be provided in these devices in a high density. In order to realize the high density mounting, a circuit pitch of a printed wiring board has to be made highly precise according to a device size, and thus development of a material and processing technology suitable for it becomes imperative.

In the case where a highly precise circuit is formed, since a contact area between a substrate and the circuit is remarkably decreased, they have to be further firmly bonded together. In order to improve an adhesive strength therebetween, it is general to utilize an anchor effect by roughing a surface of a conductor. However, when roughing the surface to be bonded, a thickness variation of the conductor is generated. This causes an etching rate difference at the time of pattern formation, and thus disturbed is to make a pattern of the circuit highly precise. Therefore, in order to realize the high precision, a surface of the conductor has to be smoother to form a flat interface between the conductor and the substrate, and thus development of an adhesive capable of exhibiting a strong adhesive strength is demanded.

On the other hand, from the viewpoint of environmental protection, a solder is progressively made lead-free. Although a process at about 260° C. was carried out in the case of using a conventional lead solder, a high temperature process at 320° C. becomes necessary in the case of using a lead-free solder. In this way, a processing temperature in the manufacturing process of the electric circuit substrate tends to be increased, and thus development of an adhesive having high heat resistance which can withstand this high temperature process becomes imperative. However, there are few organic materials which can withstand a high temperature of 300° C. An epoxy resin, an acryl resin and the like which have used in a conventional interlayer insulation adhesive are difficult to withstand a manufacturing process exceeding 300° C., and a polyimide-based adhesive excelling in a adhesive strength, solder heat resistance, chemical resistance, a mechanical strength, an electrical property and the like is gathering attention.

A method in which a thermoplastic polyimide is formed on a resin layer made of a polyimide by applying it so as to be laminated together, or a hotmelt-type polyimide adhesive which is dissolved in a solvent, applied on a metal foil and dried, and then attached to another substrate by heat press is proposed (see, for example, patent documents 1 and 2). However, an ingredient contributing to an adhesive property causes decrease of a glass transition temperature to lower solder heat resistance. Therefore, there was a problem of being unable to achieve a balance between the adhesive property and the solder heat resistance.

### PRIOR ART DOCUMENT

### Patent Document

Patent Document 1: JP-A H08-176300

Patent Document 2: JP-A 2011-195771

### SUMMARY OF INVENTION

### Problem to be Solved by Invention

An object of the present invention is to provide a polyimide copolymer excelling in solder heat resistance and an adhesive property, and a molded article thereof.

### Means of Solving Problem

As a result of an extensive study in order to solve the above problem, the inventor have found out that such a problem can be solved using a polyimide copolymer obtained by copolymerizing an acid dianhydride and a specific diamine and/or diisocyanate, and have completed the present invention.

Namely, [1] a polyimide copolymer of the present invention is characterized by copolymerizing:

(A) an acid dianhydride ingredient;

(B) a diamine and/or diisocyanate ingredient represented by the following general formulas (1) to (3):

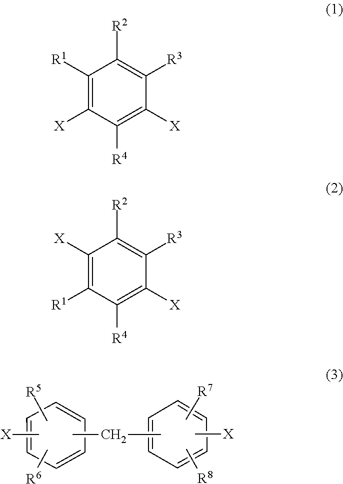

where, in the formulas, X is an amino group or an isocyanate group, each of R¹ to R⁸ is independently a hydrogen atom, an alkyl group having a carbon number of 1 to 4, an alkenyl group having a carbon number of 2 to 4 or an alkoxy group having a carbon number of 1 to 4, at least one of R¹ to R⁴ is not a hydrogen atom, and at least one of R⁵ to R⁸ is not a hydrogen atom; and

(C) a diamine and/or diisocyanate ingredient having at least one kind selected from an ether group and a carboxyl group.

[2] Here, it is preferred that the ingredient (A) is at least one kind selected from 3,3′,4,4′-biphenyl tetracarboxylic dianhydride, 4,4′-oxydiphthalic dianhydride, pyromellitic dianhydride, 4,4′-[propane-2,2-diyl bis(1,4-phenyleneoxy)]diphthalic dianhydride.

[3] Furthermore, a diamine and/or diisocyanate ingredient different from the ingredient (B) and the ingredient (C) may be further copolymerized as an ingredient (D).

[4] Further, a polyimide copolymer of the present invention is characterized by having a structural unit represented by the following general formula (101) and a structural unit represented by the following general formula (102):

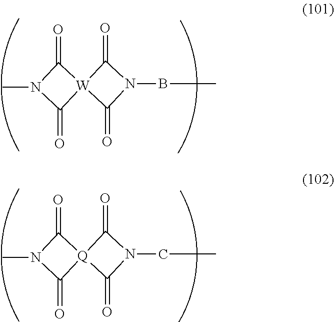

where, in the formulas, W and Q are tetravalent organic groups derived from acid dianhydrides, W and Q may be the same or different,

in the formula (101), B is a divalent organic group derived from a diamine and/or diisocyanate compound represented by the following general formulas (1) to (3):

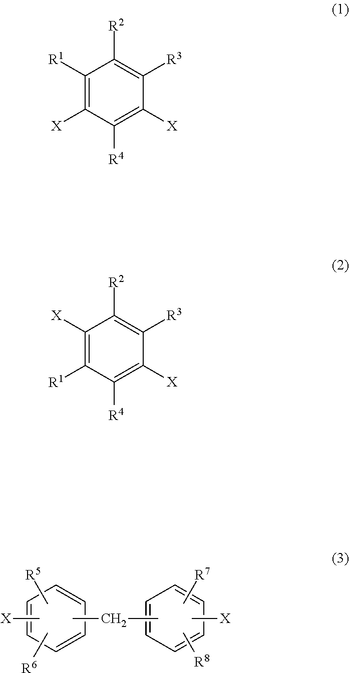

in the formula (102), C is a divalent organic group derived from a diamine and/or diisocyanate compound having at least one kind selected from an ether group and a carboxyl group.

[5] Furthermore, the polyimide copolymer of the present invention may further comprise a structural unit represented by the following general formula (103):

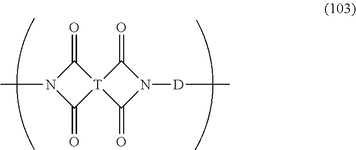

where, in the formula, T is a tetravalent organic group derived from an acid dianhydride, and T may be the same as or different from W and Q, and

where, in the formula (103), D is a divalent organic group derived from a diamine and/or diisocyanate compound different from both B in the formula (101) and C in the formula (102).

[6] A molded article of the present invention is characterized by comprising the polyimide copolymer according to any one of [1] to [5].

### Effect of Invention

The present invention provides a polyimide copolymer and molded article excelling in solder heat resistance and in adhesive properties to a metal foil or various kinds of films.

The reasons for this may be as follows, though not intended to limit the present invention. By using the ingredient (B) number of imide groups are increased, which raise a glass transition temperature, and thus the solder heat resistance is improved. Further, by introducing an ether group into the ingredient (C), fluidity is increased, improving a bonding efficiency by, for example, anchoring effect. In addition, by introducing a carboxyl group, the adhesive strength is improved through chemical interaction with a surface of a metal foil or the various kinds of films. Furthermore, by appropriately combining the ingredient (D) therewith, it is possible to adjust the glass transition temperature, a water absorptivity, a coefficient of linear thermal expansion, and the like.

### Mode for Carrying Out Invention

Hereinafter, detail description will be made on embodiments of the present invention.

A polyimide copolymer and a molded article using the same according to the present invention is obtained by polymerizing an acid dianhydride ingredient and a specific diamine and/or diisocyanate ingredient.

Hereinafter, description will be made on the embodiments of the polyimide copolymer and the molded article according to the present invention.

(Polyimide Copolymer)

The polyimide copolymer of the present invention is obtained by copolymerizing (A) an acid dianhydride ingredient, (B) a diamine and/or diisocyanate ingredient having a structure represented by general formulas (1) to (3), and (C) a diamine and/or diisocyanate ingredient having at least one kind selected from an ether group and a carboxyl group. A structure of the ingredient (B) will be described later.

The acid dianhydride which is the ingredient (A) is not especially limited as long as it is used for producing a polyimide, and a publicly known acid dianhydride can be used. Examples thereof include 3,3′,4,4′-biphenyl tetracarboxylic dianhydride, pyromellitic dianhydride, 4,4′-oxydiphthalicdianhydride, 1,2,4,5-benzene tetracarboxylic dianhydride, 1,2,3,4-pentane tetracarboxylic dianhydride, 5-(2,5-dioxotetrahydrofurfuryl)-3-methyl-3-cyclohexene-1,2-dicarboxylic acid dianhydride, 5-(2,5-dioxotetrahydrofurfuryl)-3-cyclohexene-1,2-dicarboxylic acid dianhydride, cyclopentane tetracarboxylic dianhydride, ethyleneglycol bistrimellitate dianhydride, 2,2′,3,3′-diphenyl tetracarboxylic dianhydride, thiophene-2,3,4,5-tetracarboxylic dianhydride, 3,3′,4,4′-benzophenone tetracarboxylic dianhydride, 3,3′,4,4′-biphenyl tetracarboxylic acid dianhydride, 2,3,3′,4-biphenyl tetracarboxylic dianhydride, 2,3,6,7-naphthalene tetracarboxylicdianhydride, 1,2,5,6-naphthalene tetracarboxylic dianhydride, 1,4,5,8-naphthalene tetracarboxylic dianhydride, 2,2′-bis(3,4-dicarboxyphenyl) propane dianhydride, bis(3,4-dicarboxyphenyl) sulfone dianhydride, perylene-3,4,9,10-tetracarboxylic dianhydride, bis(3,4-dicarboxyphenyl) ether dianhydride, ethylene tetracarboxylic dianhydride, 4,4′-[propane-2,2-diyl bis(1,4-phenyleneoxy)]diphthalic dianhydride, and the like. These compounds may be used singly, or in a mixture of two or more kinds thereof. Among them, 3,3′,4,4′-biphenyl tetracarboxylic dianhydride, 4,4′-oxydiphthalic dianhydride, pyromellitic dianhydride and 4,4′-[propane-2,2-diyl bis(1,4-phenyleneoxy)]diphthalic acid dianhydride are preferable from the viewpoint of the adhesive property. Moreover, 3,3′,4,4′-biphenyl tetracarboxylic dianhydride and 4,4′-[propane-2,2-diyl bis(1,4-phenyleneoxy)]diphthalic acid dianhydride are especially preferable from the viewpoints of both the solder heat resistance and the adhesive property.

The polyimide copolymer of the present invention uses, as the ingredient (B), at least one kind of a diamine and/or a diisocyanate represented by the following general formulas (1) to (3):

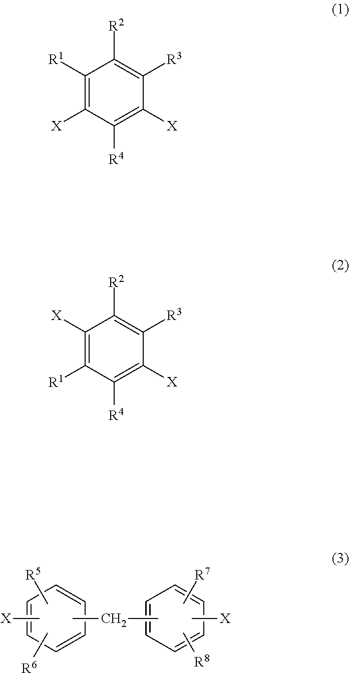

wherein X is an amino group or an isocyanate group, each of R¹ to R⁸ is independently a hydrogen atom, an alkyl group having a carbon number of 1 to 4, an alkenyl group having a carbon number of 2 to 4 or an alkoxy group having a carbon number of 1 to 4, at least one of R¹ to R⁴ is not a hydrogen atom, and at least one of R⁵ to R⁸ is not a hydrogen atom. By using the ingredient (B), it is possible to improve solubility into an organic solvent, and to increase a glass transition temperature to improve solder heat resistance. Among them, diethyl toluene diamine (DETDA) is preferable from the viewpoint that it is easily available and inexpensive and can appropriately exhibit the effect of the present invention. DETDA is represented by the above general formula (1) or (2) in which two of R¹ to R⁴ are ethyl groups and other two are a methyl group and a hydrogen atom. Further, a compound represented by the above general formula (3) in which R⁵ to R⁸ are a methyl group or an ethyl group is preferable.

The polyimide copolymer of the present invention uses, as the ingredient (C), a diamine and/or diisocyanate having at least one kind selected from an ether group and a carboxyl group. By using the ingredient (C), it is possible to improve the adhesive property of the resultant polyimide copolymer. As the ingredient (C), only one kind of them may be used, or two or more kinds of them may be used by being mixed with each other.

Examples of the ingredient (C) having the ether group(s) include compounds represented by the following general formulas (4) to (6):

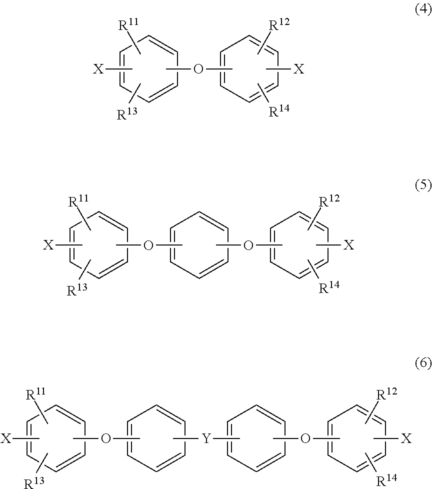

where X is an amino group or an isocyanate group, each of R¹¹ to R¹⁴ is independently a hydrogen atom, an alkyl group having a carbon number of 1 to 4, an alkenyl group having a carbon number of 2 to 4, an alkoxy group having a carbon number of 1 to 4, a hydroxyl group, a carboxyl group, or a trifluoromethyl group, and Y is preferably at least one kind selected from the following groups:

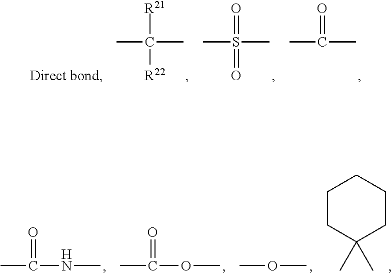

(each of R²¹ to R²² is independently a hydrogen atom, an alkyl group having a carbon number of 1 to 4, an alkenyl group having a carbon number of 2 to 4, an alkoxy group having a carbon number of 1 to 4, a hydroxyl group, a carboxyl group, or a trifluoromethyl group).

Examples of the ingredient (C) having the carboxyl group(s) include compounds represented by the following general formulas (7) to (12):

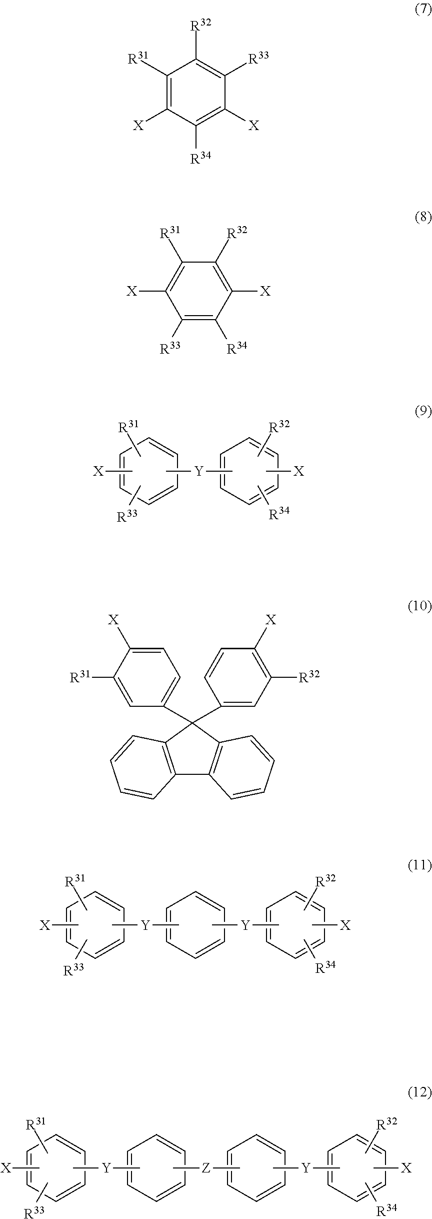

where X is an amino group or an isocyanate group, each of R³¹ to R³⁴ is independently a hydrogen atom, an alkyl group having a carbon number of 1 to 4, an alkenyl group having a carbon number of 2 to 4, an alkoxy group having a carbon number of 1 to 4, a hydroxyl group, a carboxyl group, or a trifluoromethyl group, Y and Z are preferably at least one kind selected from the following group:

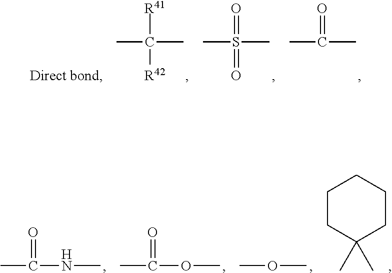

(each of R⁴¹ to R⁴² is independently a hydrogen atom, an alkyl group having a carbon number of 1 to 4, an alkenyl group having a carbon number of 2 to 4, an alkoxy group having a carbon number of 1 to 4, a hydroxyl group, a carboxyl group, or a trifluoromethyl group, and at least one of R³¹ to R³⁴ and/or R⁴¹ to R⁴² has to be the carboxyl group).

In the polyimide copolymer of the present invention, a molar ratio of the ingredient (B) to the ingredient (C) which are the diamine and/or the diisocyanate is preferably in the range of 1:2 to 2:1.

In the case where the content of the ingredient (B) is increased, the glass transition temperature is increased to improve the solder heat resistance, but an adhesive strength is decreased due to decrease of the content of the ingredient (C) which contributes to the adhesive property. Further, In the case where the content of the ingredient (C) is increased, the adhesive property is improved, but the solder heat resistance is decreased due to decrease of the content of the ingredient (B). By setting the molar ratio to the above mentioned range, it becomes possible to achieve both the solder heat resistance and the adhesive property.

A weight average molecular weight of the polyimide copolymer of the present invention is preferably in the range of 20,000 to 200,000, and more preferably in the range of 35,000 to 150,000. With the weight average molecular weight of the polyimide copolymer being in the above mentioned range, a good handling property is obtained. Further, in the case where the polyimide copolymer of the present invention is dissolved into the organic solvent, a concentration of the polyimide copolymer in the organic solvent is not especially limited, but is preferably, for example, in the range of about 5 to 35 mass %. A solution containing less than 5 mass % of the polyimide copolymer can be used, but such a dilute solution may cause low application efficiency due to the low concentration. On the other hand, a solution containing more than 35 mass % of the polyimide copolymer may has poor fluidity, causing low application efficiency.

The polyimide copolymer of the present invention may be obtained by further copolymerizing a diamine and/or diisocyanate different from the ingredient (B) and the ingredient (C) as an ingredient (D). By appropriately selecting the ingredient (D), it is possible to impart various kinds of functionalities to the polyimide copolymer.

The ingredient (D) is not especially limited, and publicly known compounds utilized for producing the polyimide can be used. Specifically, examples thereof include compounds represented by the following general formulas (13) to (22):

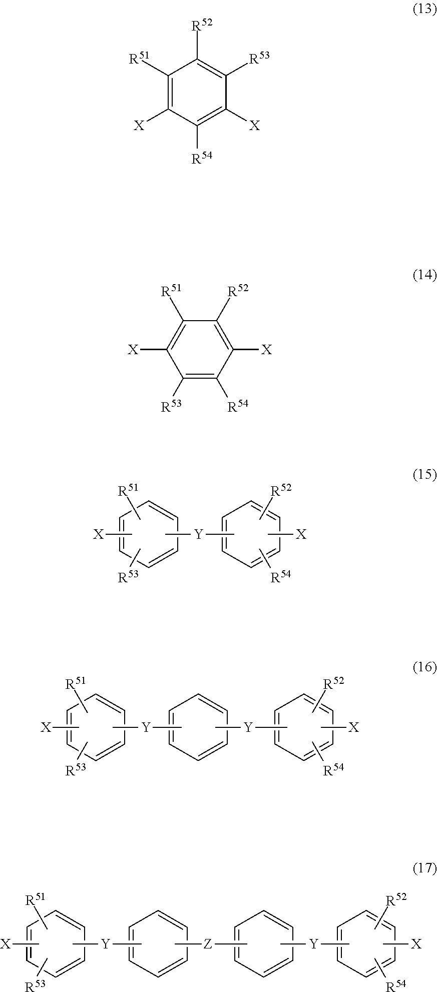

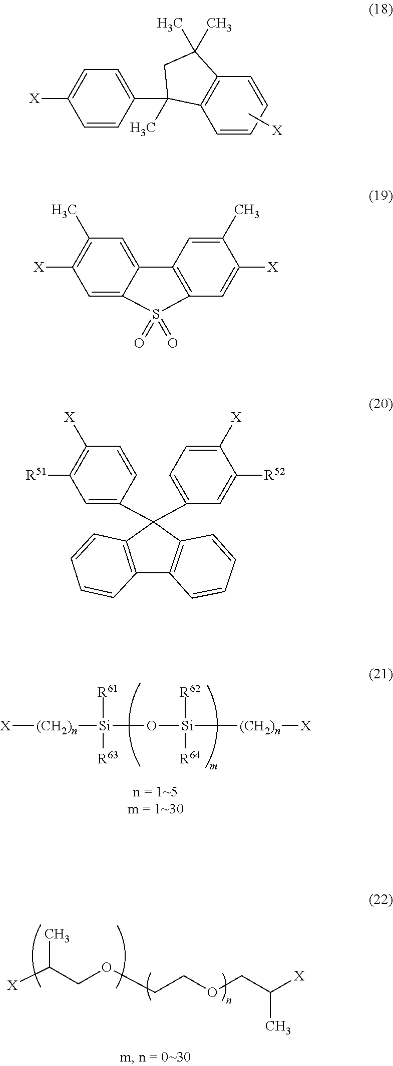

where X is an amino group or an isocyanate group, each of R⁵¹ to R⁵⁴ is independently a hydrogen atom, an alkyl group having a carbon number of 1 to 4, an alkenyl group having a carbon number of 2 to 4, an alkoxy group having a carbon number of 1 to 4, a hydroxyl group, or a trifluoromethyl group, and Y and Z are preferably at least one kind selected from the following groups:

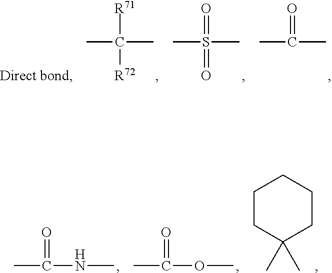

(each of R⁶¹ to R⁶⁴ is independently an alkyl group having a carbon number of 1 to 4, or a phenyl group, and each of R⁷¹ to R⁷² is independently a hydrogen atom, an alkyl group having a carbon number of 1 to 4, an alkenyl group having a carbon number of 2 to 4, an alkoxy group having a carbon number of 1 to 4, a hydroxyl group, or a trifluoromethyl group).

In this regard, a mixing ratio of the ingredient (D) is preferably in the range of about 10 to 20 mol% in the diamine and/or diisocyanate ingredients. These compounds of ingredient (D) may be used singly, or in a mixture of two or more of them.

The polyimide copolymer of the present invention has a structural unit represented by the following general formula (101) and a structural unit represented by the following general formula (102):

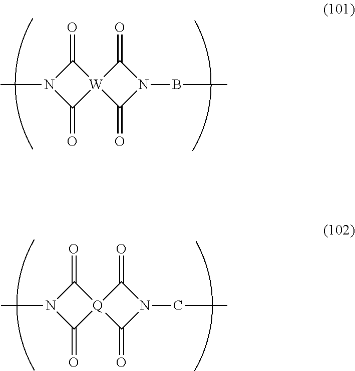

where, in the formulas, W and Q are tetravalent organic groups derived from acid dianhydrides, W and Q may be the same or different,

in the formula (101), B is a divalent organic group derived from the diamine and/or diisocyanate compound represented by the following general formulas (1) to (3):

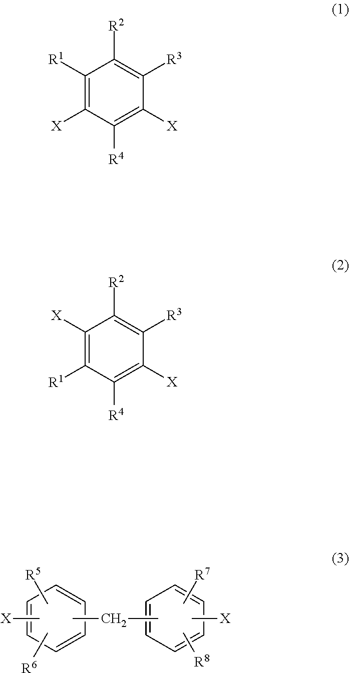

in the formula (102), C is a divalent organic group derived from the diamine and/or diisocyanate compound having the at least one kind selected from the ether group and the carboxyl group.

The structural unit represented by the general formula (101) contributes to increase of the glass transition temperature. On the other hand, the structural unit represented by the general formula (102) contributes to increase of the heat fluidity, and is effective for the improvement of the adhesive property. Since the polyimide copolymer of the present invention has the structural unit represented by the general formula (101) and the structural unit represented by the general formula (102) in one molecule thereof, it is possible to realize the excellent solder heat resistance and adhesive property.

The structure of the polyimide copolymer of the present invention is represented by, for example, the following general formula (201):

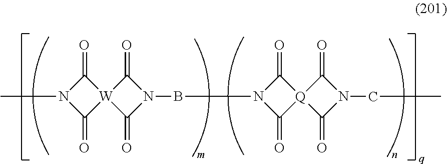

where each of m, n and q is an integer of 1 or more, and may be the same or different.

Furthermore, the polyimide copolymer of the present invention may have a structural unit represented by the following general formula (103):

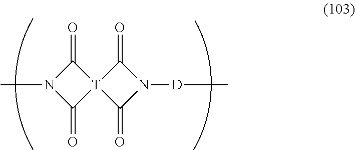

where, in the formula, T is a tetravalent organic group derived from an acid dianhydride, and T may be the same as or different from W and Q.

Further, in the formula (103), D is a divalent organic group derived from a diamine and/or diisocyanate compound different from both B in the formula (101) and C in the formula (102).

Such a structure of the polyimide copolymer is represented by, for example, the following general formula (202):

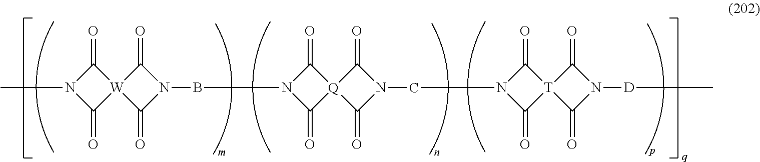

where each of m, n, p and q is an integer of 1 or more, and may be the same or different.

By a property of the structural unit represented by the general formula (103), it becomes possible to adjust the glass transition temperature, the water absorptivity, the coefficient of linear thermal expansion and the like of the resultant polyimide copolymer.

A lower limit of the glass transition temperature of the polyimide copolymer of the present invention is preferably 195° C., and more preferably 220° C. An upper limit of the glass transition temperature is preferably 300° C., and more preferably 250° C.

By setting the lower limit of the glass transition temperature to the above value, it is possible to obtain more excellent heat resistance capable of enduring an operating temperature of the lead-free solder, and by setting the upper limit of the glass transition temperature to the above value, it is possible to obtain an adhesive strength superior in delamination resistance.

A lower limit of the adhesive strength of the polyimide copolymer of the present invention is preferably 0.5 kgf/cm, and more preferably 1.0 kgf/cm.

If the adhesive strength becomes lower than the above value, there is a possibility that interlayer peeling against various kinds of substrates occurs during a manufacturing process or in practical use.

The glass transition temperature and the adhesive strength of the polyimide copolymer of the present invention can be adjusted by the kind of the ingredient (A) and a mixing amount thereof, the kind of the ingredient (B) and a mixing amount thereof, the kind of the ingredient (C) and a mixing amount thereof, the kind of the ingredient (D) to be optionally added and a mixing amount thereof, and the like.

The polyimide copolymer of the present invention can be dissolved into an organic solvent. As this organic solvent, for example, N-methyl-2-pyrolidone, N,N-dimethyl acetamide, sulfolane, N,N-dimethyl formamide, N,N-diethyl acetamide, gamma-butyrolactone, alkyleneglycol monoalkyl ether, alkyleneglycol dialkyl ether, alkyl carbitolacetate, benzoate, and the like can be used. These organic solvents may be used alone, or may be used by mixing two or more kinds of them with each other.

Next, description will be made on a method of producing the polyimide copolymer of the present invention. In order to obtain the polyimide copolymer of the present invention, either a thermal imidization method in which dehydration and cyclization are thermally performed or a chemical imidization method using a dehydration agent may be used. Hereinafter, the thermal imidization method and the chemical imidization method are described in detail step by step.

<Thermal Imidization Method>

The method of producing the polyimide copolymer of the present invention includes a step of copolymerizing (A) the acid dianhydride, (B) the diamine and/or diisocyanate represented by the above mentioned general formulas (1) to (3), and (C) the diamine and/or diisocyanate having the at least one kind selected from the ether group and the carboxyl group to produce the polyimide copolymer. At this time, the diamine and/or diisocyanate which does not correspond to the ingredient (B) and the ingredient (C) may be copolymerized as the ingredient (D). The ingredient (A), the ingredient (B), the ingredient (C), and the ingredient (D) to be optionally used are preferably polymerized in an organic solvent under the existence of a catalyst at 150 to 200° C.

In the method of producing the polyimide copolymer according to the present invention, a polymerization method is not especially limited, and any publicly known method can be used. For example, it may be a method in which a total amount of the acid dianhydride and the diamine is added to the organic solvent at once to polymerize them. Further, it may be also a method in which a total amount of the acid dianhydride is first added to the organic solvent, and then the diamine is added to the organic solvent dissolving or dispersing the acid dianhydride to polymerize them, or a method in which a total amount of the diamine is first added to the organic solvent, and then the acid dianhydride is added to the organic solvent dissolving the diamine to polymerize them.

The organic solvent used for the method of producing the polyimide copolymer according to the present invention is not especially limited. For example, N-methyl-2-pyrolidone, N,N-dimethyl acetamide, sulfolane, N,N-dimethyl formamide, N,N-diethyl acetamide and the like, gamma-butyrolactone, alkyleneglycol monoalkyl ether, alkyleneglycol dialkyl ether, alkyl carbitolacetate, and benzoate can be appropriately used. These organic solvents may be used alone, or may be used by mixing two or more of them with each other.

In the step of producing the polyimide copolymer according to the present invention, a polymerization temperature is preferably in the range of 150 to 200° C. If the polymerization temperature is lower than 150° C., there is a case that the imidization is not progressed or completed. On the other hand, if the polymerization temperature exceeds 200° C., the solvent and the unreacting raw material are oxidized, or the solvent is volatilized to increase a resin concentration. The polymerization temperature is more preferably in the range of 160 to 195° C.

The catalyst used for producing the polyimide copolymer according to the present invention is not especially limited. A publicly known imidization catalyst can be used. As the imidization catalyst, generally, pyridine can be used. Alternatively, examples thereof include a substituted or non-substituted nitrogen-containing heterocyclic compound, an N-oxide compound of a nitrogen-containing heterocyclic compound, a substituted or non-substituted amino acid compound, an aromatic hydrocarbon compound having a hydroxy group, and a heteroaromatic ring compound. Especially, a lower alkyl imidazole such as 1,2-dimethyl imidazole, N-methyl imidazole, N-benzil-2-methyl imidazole, 2-methyl imidazole, 2-ethyl-4-methyl imidazole or 5-methyl benzimidazol, an imidazol derivative such as N-benzil-2-methyl imidazole, a substituted pyridine such as isoquinoline, 3,5-dimethyl pyridine, 3,4-dimethyl pyridine, 2,5-dimethyl pyridine, 2,4-dimethyl pyridine or 4-n-propyl pyridine, p-toluenesulfonic acid, and the like can be appropriately used. An used amount of the imidization catalyst is preferably an equivalent of about 0.01 to 2 times, and more preferably an equivalent of 0.02 to 1 times with respect to an amide unit of a polyamide acid. By using the imidization catalyst, there is a case that a physical property such as elongation or tensile strength of the resultant polyimide is improved.

Further, in the step of producing the copolymer according to the present invention, in order to efficiently remove water which would be generated by an imidization reaction, an azeotrope solvent can be added to the organic solvent. As the azeotrope solvent, an aromatic hydrocarbon such as toluene, xylene or solvent naphtha, an aliphatic hydrocarbon such as cyclohexane, methyl cyclohexane or dimethyl cyclohexane, and the like can be used. In the case where the azeotrope solvent is used, an additive amount thereof is preferably in the range of about 1 to 30 mass %, and more preferably in the range of 5 to 20 mass % in a total amount of the organic solvent.

<Chemical Imidization Method>

In the case where the polyimide copolymer of the present invention is produced by the chemical imidization method, the ingredient (A), the ingredient (B), the ingredient (C), and the ingredient (D) to be optionally used are copolymerized. In the step of producing the copolymer, a dehydration agent such as acetic anhydride, and a catalyst such as triethyl amine, pyridine, picoline or quinoline are added to a polyamic acid solution, and then the same operation as the thermal imidization method is carried out. In this way, it is possible to obtain the polyimide copolymer of the present invention. In the case where the polyimide copolymer of the present invention is produced by the chemical imidization method, a preferable polymerization temperature is in the range of about room temperature to 150° C., and a preferable polymerization time is in the range of 1 to 200 hours.

Examples of the dehydration agent used for producing the polyimide copolymer of the present invention include an organic acid anhydride such as an aliphatic acid anhydride, an aromatic acid anhydride, an alicyclic acid anhydride or a heterocycle acid anhydride, or a mixture containing two or more kinds of them. Concrete examples of the organic acid anhydride include acetic anhydride, and the like.

In the production of the polyimide copolymer of the present invention by the chemical imidization method, the same imidization catalyst and organic solvent as the thermal imidization method can be used.

(Molded Article)

A molded article of the present invention means a thing containing the copolymer of the present invention. Examples thereof include a thing having a substrate and a resin layer provided on at least one surface thereof, a thing consisting of the resin layer separated from the substrate, and the like.

In this regard, the resin layer means a thing obtained by dissolving the polyimide copolymer of the present invention into the organic solvent, applying it onto the surface of the substrate, and then drying it.

In the case where the molded article is manufactured using the polyimide copolymer of the present invention, a manufacturing method is not particularly limited, and publicly known methods such as a spin coating method, a dipping method, a spraying method and a casting method can be used. Examples thereof include a method in which the polyimide copolymer of the present invention is applied onto the surface of the substrate, and then formed into a coating, film or sheet by removing the solvent

Any substrate can be used depending on the intended use of a final product. Examples of a constituent material thereof include fiber products such as a cloth; glasses; synthetic resins such as polyethylene terephthalate, polyethylene naphtha late, polyethylene, polycarbonate, triacetyl cellulose, cellophane, polyimide, polyamide, polyphenylene sulfide, polyether imide, polyether sulfone, aromatic polyamide and polysulfone; metals such as copper and aluminum; ceramics; papers; and the like. In this regard, the substrate may be transparent or may be colored by mixing various kinds of pigments and dyes with the constituent material thereof, and a surface thereof may be further processed into a mat shape. A thickness of the substrate is also not especially limited, but is preferably in the range of about 0.001 to 10 mm.

In order to dry the applied polyimide copolymer of the present invention, a normal heating dryer can be used. Examples of an atmosphere in the dryer include air, an inert gas (nitrogen, argon), and the like. A drying temperature is appropriately selected according to a boiling point of the solvent used for dissolving the polyimide copolymer of the present invention, but is normally in the range of 80 to 400° C., preferably in the range of 100 to 350° C., and more preferably in the range of 120 to 250° C. A drying time may be selected depending on a thickness, a concentration, and the kind of the solvent, but is preferably in the range of about 1 second to 360 minutes.

After drying, it is possible to obtain a product having the polyimide copolymer of the present invention as the resin layer. Further, it is also possible to obtain the resin layer as a film by being separated from the substrate.

In the case where the molded article is manufactured using the polyimide copolymer of the present invention, a filler such as silica, alumina or mica, carbon powder, a pigment, a dye, a polymerization inhibitor, a thickener, a thixotropic agent, a suspending agent, an antioxidative agent, a dispersing agent, a pH adjuster, a surface-active agent, various kinds of organic solvents, various kinds of resins, or the like can be added thereto.

Since the polyimide copolymer of the present invention excels in the solder heat resistance and the adhesive property, it is useful as a coating agent, an adhesive or the like requiring solder heat resistance. Further, the molded article of the present invention is useful as a member such as a resin coated copper (RCC), or a resin coated film of a copper-clad laminate (CCL). With an aid of a releasable substrate, it can be made into an independent film, and is useful as an interlayer insulating film, a bonding film, or the like.

### EXAMPLES

The polyimide copolymer and the molded article thereof of the present invention are explained with reference to Examples, but the polyimide copolymer and the molded article thereof of the present invention are not limited to these Examples.

### Example 1

In a 500 mL-four neck separable flask equipped with an anchor-type stirrer made of stainless, a nitrogen introduction pipe, and Dean-Stark equipment, 37.23 g (0.12 moles) of 4,4′-oxydiphthalic dianhydride (ODPA), 7.13 g (0.04 moles) of DETDA, 23.76 g (0.08 moles) of 3,3′-(m-phenylenedioxy)dianiline (APB-N), 148.85 g of N-methyl-2-pyrolidone (NMP), 1.90 g of pyridine, and 50 g of toluene were put into. After having purged with nitrogen, a reaction was carried out for 6 hours at 180° C. under nitrogen flow. Water generated by the reaction was removed from the reaction system by azeotropic distillation with toluene.

A composition ratio (parts by mass) of the ingredient (A), the ingredient (B) and the ingredient (C) used for the reaction is shown in Table 1. In the tables, “Ex.” stands for “Example”, “Com. Ex.” stands for “Comparative example”, and “n/a” stands for “not available” or “unmeasurable.”

After completion of the reaction, the reaction system was cooled to 120° C., and then 42.53 g of NMP was added thereto to obtain a polyimide copolymer solution having a concentration of 25 mass %. A structure of the obtained polyimide copolymer is represented by the following formula (23). Here, two kinds of divalent organic groups represented by the following X are present in one molecule of the polyimide copolymer represented by the following structural formula. That is, the obtained polyimide copolymer comprises a unit represented by a general formula (30) which is shown in Comparative Example 1 and a unit represented by a general formula (31) which is shown in Comparative Example 2, each mentioned below.

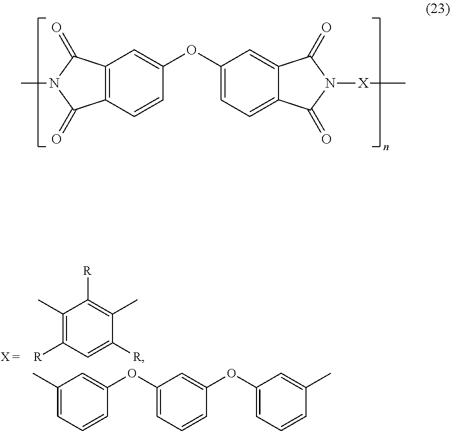

where, in the formula, R is a methyl group or an ethyl group.

### Example 2

In an apparatus as used in Example 1, 35.31 g (0.12 moles) of 3,3′,4,4′-biphenyl tetracarboxylic dianhydride (BPDA), 10.70 g (0.06 moles) of DETDA, 81.42 g of NMP, 2.85 g of pyridine, and 50 g of toluene were put into. After having purged the reaction system with nitrogen, the reactants were heated and stirred for 2 hours at 180° C. under the nitrogen flow. Water generated by the reaction was removed from the reaction system by azeotropic distillation with toluene.

Next, 17.65 g (0.06 moles) of BPDA, 35.62 g (0.12 moles) of APB-N, and 135.10 g of NMP were added to the reaction system, and then reacted by heating at 180° C. for five and half hours while stirring. Water generated by the reaction was removed from the reaction system by azeotropic distillation with toluene and pyridine. A composition ratio (parts by mass) of the ingredient (A), the ingredient (B) and the ingredient (C) used for the reaction is shown in Table 1.

After completion of the reaction, the reaction system was cooled to 120° C., and then 61.68 g of NMP was added thereto to obtain a polyimide copolymer solution having a concentration of 25 mass %. A structure of the obtained polyimide copolymer is represented by the following formula (24).

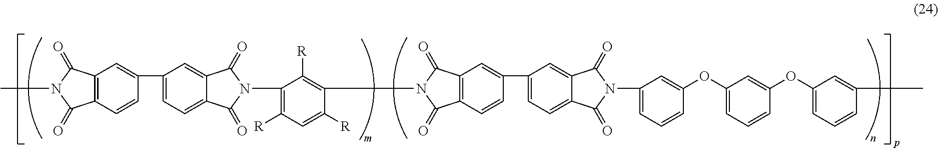

where, in the formula, R is a methyl group or an ethyl group.

### Example 3

In an apparatus as used in Example 1, 35.31 g (0.12 moles) of BPDA, 7.13 g (0.04 moles) of DETDA, 23.75 g of APB-N, 144.34 g of NMP, 1.90 g of pyridine, and 50 g of toluene were put into. After having purged with nitrogen, a reaction was carried out for 6 hours at 180° C. under the nitrogen flow. Water generated by the reaction was removed from the reaction system by azeotropic distillation with toluene. A composition ratio (parts by mass) of the ingredient (A), the ingredient (B) and the ingredient (C) used for the reaction is shown in Table 1.

After completion of the reaction, the reaction system was cooled to 120° C., and then 41.24 g of NMP was added thereto to obtain a polyimide copolymer solution having a concentration of 25 mass %. A structure of the obtained polyimide copolymer is represented by the following formula (25). Here, two kinds of divalent organic groups represented by the following X are present in one molecule of the polyimide copolymer represented by the following structural formula. That is, the obtained polyimide copolymer comprises a unit represented by a general formula (32) which is shown in Comparative Example 3 and a unit represented by a general formula (33) which is shown in Comparative Example 4, each mentioned below.

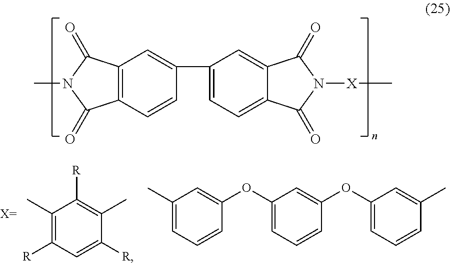

where, in the formula, R is a methyl group or an ethyl group.

### Example 4

In an apparatus as used in Example 1, 44.13 g (0.15 moles) of BPDA, 31.05 g (0.1 moles) of 4,4′-methylene bis(2,6-diethyl aniline) (M-DEA), 15.12 g (0.05 moles) of APB-N, 157.65 g of NMP, 2.37 g of pyridine, and 50 g of toluene were put into. After having purged with nitrogen, a reaction was carried out for 6 hours at 180° C. under the nitrogen flow. Water generated by the reaction was removed from the reaction system by azeotropic distillation with the toluene. A composition ratio (parts by mass) of the ingredient (A), the ingredient (B) and the ingredient (C) used for the reaction is shown in Table 2.

After completion of the reaction, the reaction system was cooled to 120° C., and then 97.02 g of NMP was added thereto to obtain a polyimide copolymer solution having a concentration of 25 mass %. A structure of the obtained polyimide copolymer is represented by the following formula (26). Here, two kinds of divalent

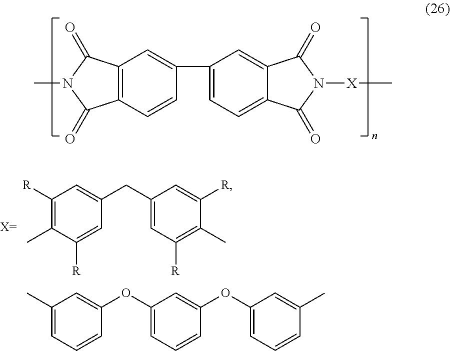

organic groups represented by the following X are present in one molecule of the polyimide copolymer represented by the following structural formula.

where, in the formula, R is a methyl group or an ethyl group.

### Example 5

In an apparatus as used in Example 1, 22.07 g (0.075 moles) of BPDA, 4.46 g (0.025 moles) of DETDA, 11.18 g (0.038 moles) of APB-N, 2.84 g (0.013 moles) of 4-amino-N-(3-aminophenyl) benzamide (3,4′-DABAN), 88.32 g of NMP, 1.18 g of pyridine, and 50 g of toluene were put into. After having purged with nitrogen, a reaction was carried out for 6 hours at 180° C. under the nitrogen flow. Water generated by the reaction was removed from the reaction system by azeotropic distillation with toluene. A composition ratio (parts by mass) of the ingredient (A), the ingredient (B), the ingredient (C) and the ingredient (D) used for the reaction is shown in Table 2.

After completion of the reaction, the reaction system was cooled to 120° C., and then 126.15 g of NMP was added thereto to obtain a polyimide copolymer solution having a concentration of 15 mass %. A structure of the obtained polyimide copolymer is represented by the following formula (27). Here, the polyimide copolymer has a molecule having three kinds of divalent organic groups represented by the following X.

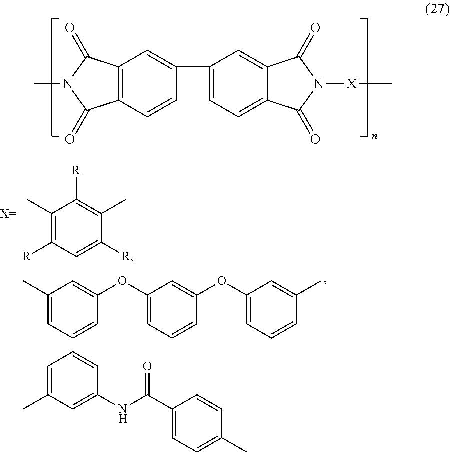

where, in the formula, R is a methyl group or an ethyl group.

### Example 6

In an apparatus as used in Example 1, 26.17 g (0.12 moles) of pyromellitic dianhydride (PMDA), 7.13 g (0.04 moles) of DETDA, 23.70 g (0.08 moles) of APB-N, 122.91 g of NMP, 1.90 g of pyridine, and 50 g of toluene were put into. After having purged with nitrogen, a reaction was carried out for 6 hours at 180° C. under the nitrogen flow. Water generated by the reaction was removed outside the reaction system by azeotropic distillation with the toluene. A composition ratio (parts by mass) of the ingredient (A), the ingredient (B) and the ingredient (C) used for the reaction is shown in Table 2.

After completion of the reaction, the reaction system was cooled to 120° C., and then 35.12 g of NMP was added thereto to obtain a polyimide copolymer solution having a concentration of 25 mass %. A structure of the obtained polyimide copolymer is represented by the following formula (28). Here, two kinds of divalent organic groups represented by the following X are contained in one molecule of the polyimide copolymer represented by the following structural formula. That is, the obtained polyimide copolymer contains a unit represented by a general formula (34) which is shown in Comparative Example 5 and a unit represented by a general formula (35) which is shown in Comparative Example 6, each mentioned below.

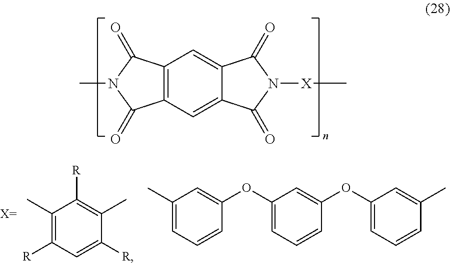

where, in the formula, R is a methyl group or an ethyl group.

### Example 7

In an apparatus as used in Example 1, 62.46 g (0.12 moles) of 4,4′-[propane-2,2-diyl bis(1,4-phenyleneoxy)]diphthalic acid dianhydride (BisDA), 10.70 g (0.06 moles) of DETDA, 9.59 g (0.06 moles) of 3,5-diaminobenzoic acid (3,5-DABA), 182.98 g of NMP, 1.90 g of pyridine, and 50 g of toluene were put into. After having purged with nitrogen,a reaction was carried out for 6 hours at 180° C. under the nitrogen flow. Water generated by the reaction was removed outside the reaction system by azeotropic distillation with the toluene. A composition ratio (parts by mass) of the ingredient (A), the ingredient (B) and the ingredient (C) used for the reaction is shown in Table 2.

After completion of the reaction, the reaction system was cooled at 120° C., and then 52.28 g of NMP was added thereto to obtain a polyimide copolymer solution having a concentration of 25 mass %. A structure of the obtained polyimide copolymer is represented by the following formula (29). Here, two kinds of divalent organic groups represented by the following X are contained in one molecule of the polyimide copolymer represented by the following structural formula.

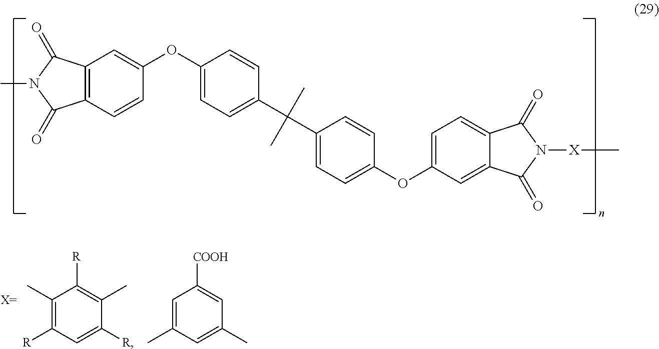

where in the formula, R is a methyl group or an ethyl group.

### Comparative Example 1

In an apparatus as used in Example 1, 40.33 g (0.13 moles) of ODPA, 38.44 g (0.13 moles) of APB-N, 137.58 g of NMP, 2.06 g of pyridine, and 50 g of toluene were put into. After having purged with nitrogen, a reaction was carried out for 6 hours at 180° C. under the nitrogen flow. Water generated by the reaction was removed outside the reaction system as an azeotropic mixture with the toluene and the pyridine. A composition ratio (parts by mass) of the ingredient (A) and the ingredient (C) used for the reaction is shown in Table 1.

After completion of the reaction, the reaction system was cooled at 120° C., and then 84.66 g of NMP was added thereto to obtain a polyimide copolymer solution having a concentration of 25%. A structure of the obtained polyimide copolymer is represented by the following formula (30).

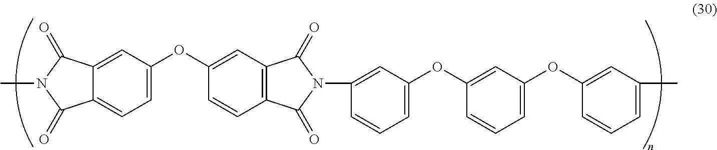

### Comparative Example 2

In an apparatus as used in Example 1, 55.84 g (0.18 moles) of ODPA, 32.33 g (0.18 moles) of DETDA, 151.70 g of NMP, 2.85 g of pyridine, and 50 g of toluene were put into. After having purged with nitrogen, a reaction was carried out for 6 hours at 180° C. under the nitrogen flow. Water generated by the reaction was removed outside the reaction system as an azeotropic mixture with the toluene and the pyridine. A composition ratio (parts by mass) of the ingredient (A) and the ingredient (B) used for the reaction is shown in Table 1.

After completion of the reaction, the reaction system was cooled at 120° C., and then 93.35 g of NMP was added thereto to obtain a polyimide copolymer solution having a concentration of 25%. A structure of the obtained polyimide copolymer is represented by the following formula (31).

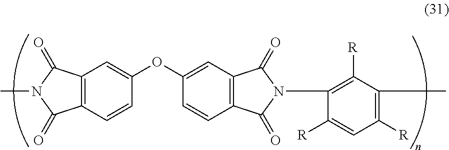

where in the formula, R is a methyl group or an ethyl group.

### Comparative Example 3

In an apparatus as used in Example 1, 44.13 g (0.15 moles) of BDPA, 44.34 g (0.15 moles) of APB-N, 154.26 g of NMP, 2.37 g of pyridine, and 50 g of toluene were put into. After having purged with nitrogen, the reactants were heated and stirred for 6 hours at 180° C. under the nitrogen flow. Water generated by the reaction was removed outside the reaction system as an azeotropic mixture with the toluene and the pyridine. A composition ratio (parts by mass) of the ingredient (A) and the ingredient (C) used for the reaction is shown in Table 1.

After completion of the reaction, the reaction system was cooled at 120° C., and then 94.93 g of NMP was added thereto to obtain a polyimide copolymer solution having a concentration of 25%. A structure of the obtained polyimide copolymer is represented by the following formula (32).

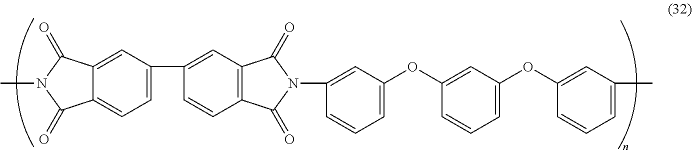

### Comparative Example 4

In an apparatus as used in Example 1, 52.96 g (0.18 moles) of BDPA, 32.32 g (0.18 moles) of DETDA, 146.33 g of NMP, 2.85 g of pyridine, and 50 g of toluene were put into. After having purged with nitrogen, the reactants were heated and stirred for 6 hours at 180° C. under the nitrogen flow. Water generated by the reaction was removed outside the reaction system as an azeotropic mixture with the toluene and the pyridine. A composition ratio (parts by mass) of the ingredient (A) and the ingredient (B) used for the reaction is shown in Table 1.

After completion of the reaction, the reaction system was cooled at 120° C., and then 90.05 g of NMP was added thereto to obtain a polyimide copolymer solution having a concentration of 25%. A structure of the obtained polyimide copolymer is represented by the following formula (33).

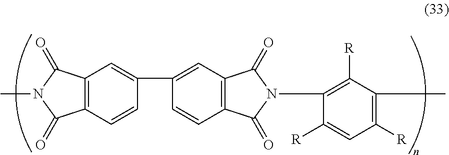

where in the formula, R is a methyl group or an ethyl group.

### Comparative Example 5

In an apparatus as used in Example 1, 32.72 g (0.15 moles) of PMDA, 44.27 g (0.15 moles) of APB-N, 132.94 g of NMP, 2.37 g of pyridine, and 50 g of toluene were put into. After having purged with nitrogen, the reactants were heated at 180° C. under the nitrogen flow to start a reaction. However, a resin ingredient was precipitated after one and half hours from the start of the reaction. A composition ratio (parts by mass) of the ingredient (A) and the ingredient (C) used for the reaction is shown in Table 2. A structure of the obtained resin ingredient is represented by the following formula (34).

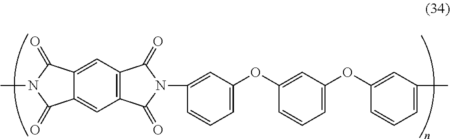

### Comparative Example 6

In an apparatus as used in Example 1, 52.35 g (0.24 moles) of PMDA, 43.04 g (0.24 moles) of DETDA, 161.09 g of NMP, 3.80 g of pyridine, and 50 g of toluene were put into. After having purged with nitrogen, the inside of the reaction system was substituted with nitrogen the reactants were heated and stirred for 6 hours at 180° C. under the nitrogen flow. Water generated by the reaction was removed outside the reaction system as an azeotropic mixture with the toluene and the pyridine. A composition ratio (parts by mass) of the ingredient (A) and the ingredient (B) used for the reaction is shown in Table 2.

After completion of the reaction, the reaction system was cooled at 120° C., and then 99.13 g of NMP was added thereto to obtain a polyimide copolymer solution having a concentration of 25%. A structure of the obtained polyimide copolymer is represented by the following formula (35).

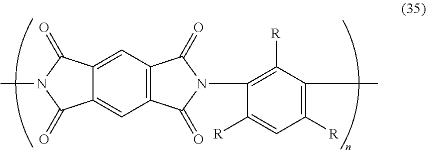

where in the formula, R is a methyl group or an ethyl group.

A Solubility in solvent and a glass transition temperature of the polyimide copolymer of each of Examples and Comparative Examples were evaluated. As to molded article, samples for evaluation were molded by vacuum press into two kinds of forms of RCC and a bonding film, and then an adhesive strength and solder heat resistance thereof were measured.

(Manufacturing of RCC)

The polyimide copolymer solution obtained in each of Examples and Comparative Examples was applied onto an electrolysis copper foil having a thickness of 18 μm and a surface roughness (Rz) of 2.0 μm so that a dry film thickness thereof became 10 μm using a spin coating method. Thereafter, it was fixed on a stainless frame, and temporarily dried for 5 minutes at 120° C. After the temporarily drying, it was dried for 30 minutes at 180° C. and for 1 hour at 250° C. under the nitrogen atmosphere to manufacture the RCC.

(Manufacturing of Bonding Film)

The polyimide copolymer solution obtained in each of Examples and Comparative Examples was applied by spin coating onto a PET film having a thickness of 125 μm in such an amount that a dried film thickness thereof became 20 μm. Thereafter, it was fixed on a stainless frame, and temporarily dried for 5 minutes at 120° C. After the temporarily drying, the PET film was peeled, and then the obtained polyimide copolymer in the form of film was fixed on the stainless frame, and then dried for 30 minutes at 180° C. and for 1 hour at 250° C. under the nitrogen atmosphere to manufacture the bonding film.

The above mentioned RCC and bonding film were used and bonded to an electrolysis copper foil having a surface roughness (Rz) of 2.0 μm using a vacuum press machine to produce multilayer substrates. The pressing was carried out by increasing a surface pressure to 5 MPa, which was kept for 5 minutes at 110° C., followed by increasing the temperature to 300° C., which was kept for 30 minutes.

(Solubility in Solvent)

When the polyimide copolymer solution was prepared in each of Examples and Comparative Examples, a polyimide copolymer which was soluble in the solvent used for polymerizing was rated as “A”, while those precipitated from the solvent during the polymerization process to exhibit the insolubility was rated as “B”. The results are shown in Table 1 and Table 2.

(Glass Transition Temperature)

By using the above mentioned bonding film, a glass transition temperature thereof was measured. For the measurement, DSC6200 (produced by Seiko Instruments Inc.) was used. Here, the film was heated up to 500° C. at a temperature increasing rate of 10° C./min, and a midpoint glass transition temperature was defined as the glass transition temperature. The obtained results are shown in Table 1 and Table 2.

(Adhesive Strength)

The above mentioned multilayer substrate was processed into a test piece having a width of 10 mm, and then the bonding strength at 180° thereof was measured by using a creep meter (“RE2-33005B” produced by Yamaden co., ltd.). The measurement was carried out twice at a pulling rate of 1 mm/sec, and a maximum stress was defined as the adhesive strength. The results are shown in Table 1 and Table 2. It should be noted that the same results were obtained for both the multilayer substrate in which the RCC was used and the multilayer substrate in which the bonding film was used.

(Solder Heat Resistance)

The above mentioned multilayer substrate was processed into a test piece having a size of 25 mm×25 mm. The test piece was floated on a solder bath at a predetermined temperature (260° C., 280° C., 300° C., or 320° C.) for 60 seconds, and then appearance degradation such as peeling or blistering was observed and rated according to the following criteria. The results are shown in Table 1 and Table 2. It should be noted that the same results were obtained in both the laminated board in which the RCC was used and the laminated board in which the bonding film was used.

A: No degradation in appearance was observed.

B: Peeling or blistering having a diameter of less than 1 mm was observed.

C: Peeling or blistering having a diameter of 1 mm or more was observed.

TABLE 1

| | | | | Com. | Com. | | | Com. | |
|---|---|---|---|---|---|---|---|---|---|
| | | | Ex. 1 | Ex. 1 | Ex. 2 | Ex. 2 | Ex. 3 | Ex. 3 | Com. Ex. 4 |
| Acid di- | (A) | (A1) ODPA | 100 | 100 | 100 | — | — | — | — |
| anhydride | | (A2) BPDA | — | — | — | 100 | 100 | 100 | 100 |
| | | (A3) PMDA | — | — | — | — | — | — | — |
| | | (A4) BisDA | — | — | — | — | — | — | — |
| Diamine | (B) | (B1) | 33 | — | 100 | 33 | 33 | — | 100 |
| | | DETDA | | | | | | | |
| | | (B2) M- | — | — | — | — | — | — | — |
| | | DEA | | | | | | | |
| | (C) | (C1) APB-N | 67 | 100 | — | 67 | 67 | 100 | — |
| | | (C2) 3,5- | — | — | — | — | — | — | — |
| | | DABA | | | | | | | |
| | (D) | (D1) 3,4- | — | — | — | — | — | — | — |
| | | DABAN | | | | | | | |

| Solubility in solvent | | A | A | A | A | A | A | A |
|---|---|---|---|---|---|---|---|---|
| Glass transition temperature | | 197 | 167 | 340 | 227 | 226 | 192 | >500 |
| (° C.) | | | | | | | | |
| adhesive strength (kgf/cm) | | 1.7 | 1.7 | 0 | 1.5 | 1.7 | 1.7 | 0 |
| Solder heat | 260° C. 60 s | A | B | C | A | A | A | C |
| resistance | 280° C. 60 s | A | C | C | A | A | A | C |
| | 300° C. 60 s | A | C | C | A | A | C | C |
| | 320° C. 60 s | B | C | C | A | A | C | C |

TABLE 2

| | | | | | | Com. | Com. | |
|---|---|---|---|---|---|---|---|---|
| | | | Ex. 4 | Ex. 5 | Ex. 6 | Ex. 5 | Ex. 6 | Ex. 7 |
| Acid di- | (A) | (A1) ODPA | — | — | — | — | — | — |
| anhydride | | (A2) BPDA | 100 | 100 | — | — | — | — |
| | | (A3) PMDA | — | — | 100 | 100 | 100 | — |
| | | (A4) BisDA | — | — | — | — | — | 100 |
| Diamine | (B) | (B1) | — | 33 | 33 | — | 100 | 50 |
| | | DETDA | | | | | | |
| | | (B2) M- | 67 | — | — | — | — | — |
| | | DEA | | | | | | |
| | (C) | (C1) APB-N | 33 | 51 | 67 | 100 | — | — |
| | | (C2) 3,5- | — | — | — | — | — | 50 |
| | | DABA | | | | | | |
| | (D) | (D1) 3,4- | — | 17 | — | — | — | — |
| | | DABAN | | | | | | |

| Solubility in solvent | | A | A | A | B | A | A |
|---|---|---|---|---|---|---|---|
| Glass transition temperature | | 240 | 249 | 243 | n/a | >500 | 248 |
| (° C.) | | | | | | | |
| adhesive strength (kgf/cm) | | 1.2 | 1.6 | 1.5 | n/a | 0 | 1.4 |
| Solder heat | 260° C. 60 s | A | A | A | n/a | C | A |
| resistance | 280° C. 60 s | A | A | A | n/a | C | A |
| | 300° C. 60 s | A | A | A | n/a | C | A |
| | 320° C. 60 s | A | A | B | n/a | C | A |

(Discussion)

As shown in Table 1, it was found that Comparative Example 1, which was obtained from the ingredient (A) and the ingredient (C) to have only the structural unit represented by the above mentioned general formula (102), had a good adhesive strength, but had a low glass transition temperature, resulting in insufficient solder heat resistance. On the other hand, it was found that Comparative Example 2, which was obtained from the ingredient (A) and the ingredient (B) to have only the structural unit represented by the above mentioned general formula (101), had a high glass transition temperature, but had a low adhesive strength to be unable to follow a dimensional change of the material thereof due to the heat of the solder bath. In contrast, it was confirmed that Example 1, which was obtained from the ingredient (A), the ingredient (B) and the ingredient (C) to have the structural unit represented by above mentioned general formula (101) and the structural unit represented by the general formula (102), had an excellent adhesive strength and superior solder heat resistance.

From the above results, the effects of the polyimide copolymer of the present invention, which had the structural unit represented by the general formula (101) and the structural unit represented by the general formula (102) in one molecule thereof, were confirmed.

Further, from the results of Comparative Example 3 in Table 1, of which ingredient (A) was BPDA, it was confirmed that the copolymer, which was obtained from the ingredient (A) and the ingredient (C) only, did not have enough solder heat resistance. On the other hand, from the results of Comparative Example 4 in Table 1, of which ingredient (A) was BPDA, it was confirmed that the copolymer, which was obtained from the ingredient (A) and the ingredient (B) only, had a low bonding strength and could not follow the dimension change of the material thereof due to the heat of the solder bath. In contrast, it was confirmed that Example 2 and Example 3, which were obtained from the ingredient (A), the ingredient (B) and the ingredient (C), had excellent adhesive strength and superior solder heat resistance.

In this regard, the manufacturing methods of Example 2 and Example 3 are different from each other, and thus the structures of the obtained polyimide copolymers are also different from each other. That is, in Example 2, the structural units represented by the general formula (101) and the structural units represented by the general formula (102) are block-copolymerized, while in Example 3, the structural units represented by the general formula (101) and the structural units represented by the general formula (102) are random-copolymerized. However, it was confirmed that both Example 2 and Example 3 had excellent adhesive strength and superior solder heat resistance.

From Table 2, it was found that Example 4, in which the kind of the ingredient (C) was changed from Example 3, also had an excellent adhesive strength and superior solder heat resistance. Further, Example 5, in which the ingredient (D) was added to the composition of Example 3, also exhibited excellent adhesive strength and superior solder heat resistance.

Furthermore, from the results of Comparative Example 5 in Table 2, where the ingredient (A) was PMDA, it was found that the copolymer, which was obtained from only the ingredient (A) and the ingredient (C), did not exhibit enough solvent solubility. From the results of Comparative Example 6, where the ingredient (A) was PMDA, it was found that the copolymer, which was obtained from only the ingredient (A) and the ingredient (B), had low adhesive strength and did not exhibit enough solder heat resistance. In contrast, it was confirmed that Example 6, which was obtained from the ingredient (A), the ingredient (B) and the ingredient (C), had high solvent solubility, excellent adhesive strength and superior solder heat resistance.

It was found that Example 7, in which used was BisDA as the ingredient (A), DETDA as the ingredient (B) and 3,5-DABA as the ingredient (C), also had excellent bonding strength and superior solder heat resistance.

From the above results, it was confirmed that the polyimide copolymer of the present invention makes a good adhesive having solder heat resistance applicable to a process using lead-free solder, and a adhesive strength of 1.0 kgf/cm or more.

1. A polyimide copolymer obtained by copolymerizing:
(A) an acid dianhydride ingredient;
(B) a diamine and/or diisocyanate ingredient each represented by one of the following general formulas (1) to (3): 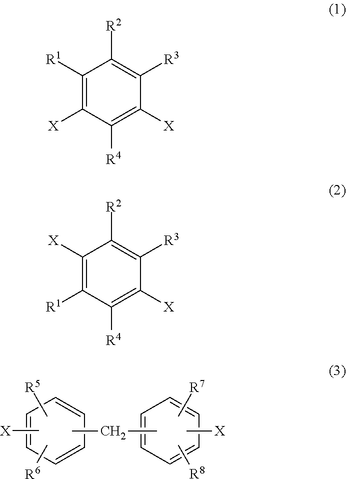
where, in the formulas, X is an amino group or an isocyanate group, each of R¹ to R⁸ is independently a hydrogen atom, an alkyl group having a carbon number of 1 to 4, an alkenyl group having a carbon number of 2 to 4 or an alkoxy group having a carbon number of 1 to 4, at least one of R¹ to R⁴ is not a hydrogen atom, and at least one of R⁵ to R⁸ is not a hydrogen atom; and
(C) a diamine and/or diisocyanate ingredient having at least one kind selected from an ether group and a carboxyl group.

2. The polyimide copolymer according to claim 1, wherein the ingredient (A) is at least one kind selected from 3,3′,4,4′-biphenyl tetracarboxylic acid dianhydride, 4,4′-oxydiphthalic acid dianhydride, pyromellitic acid dianhydride, 4,4′-[propane-2,2-diyl bis(1,4-phenyleneoxy)]diphthalic acid dianhydride.

3. The polyimide copolymer according to claim 1, obtained by further copolymerizing a diamine and/or diisocyanate different from the ingredient (B) and the ingredient (C) as an ingredient (D).

4. A polyimide copolymer having a structural unit represented by the following general formula (101) and a structural unit represented by the following general formula (102): 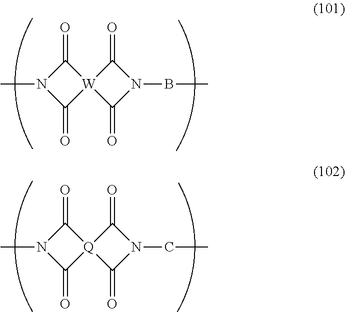
where, in the formulas, W and Q are tetravalent organic groups derived from acid dianhydrides, and W and Q may be the same or different,
in the formula (101), B is a divalent organic group derived from a diamine and/or diisocyanate compound each represented by one of the following general formulas (1) to (3): 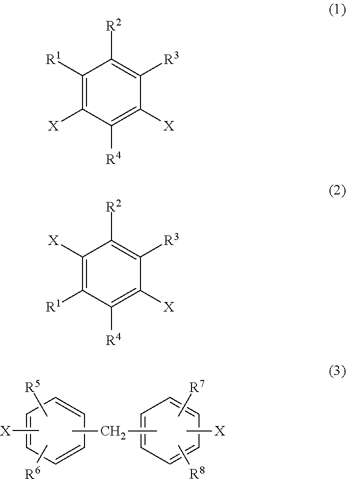
in the formulas (1), (2) and (3), X is an amino group or an isocyanate group, each of R¹ to R⁸ is independently a hydrogen atom, an alkyl group having a carbon number of 1 to 4, an alkenyl group having a carbon number of 2 to 4 or an alkoxy group having a carbon number of 1 to 4, at least one of R¹ to R⁴ is not a hydrogen atom, and at least one of R¹ to R⁸ is not a hydrogen atom,
in the formula (102), C is a divalent organic group derived from a diamine and/or diisocyanate compound having at least one kind selected from an ether group and a carboxyl group.

5. The polyimide copolymer according to claim 4, further having a structural unit represented by the following general formula (103): 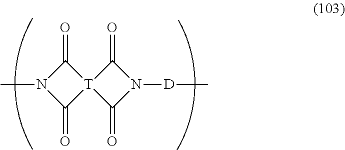
where, in the formula, T is a tetravalent organic group derived from an acid dianhydride, and T may be the same as or different from W and Q, and
where, in the formula (103), D is a divalent organic group derived from a diamine and/or diisocyanate compound different from both B in the formula (101) and C in the formula (102).

6. A molded article comprising the polyimide copolymer according to claim 1.

7. The polyimide copolymer according to claim 2, obtained by further copolymerizing a diamine and/or diisocyanate different from the ingredient (B) and the ingredient (C) as an ingredient (D).

8. A molded article comprising the polyimide copolymer according to claim 2.

9. A molded article comprising the polyimide copolymer according to claim 3.

10. A molded article comprising the polyimide copolymer according to claim 4.

11. A molded article comprising the polyimide copolymer according to claim 5.
